(19) United States
(12) Patent Application Publication
(10) Pub. No.: US 2005/0030398 A1
(43) Pub. Date: Feb. 10, 2005

(54) Hybrid two color per pixel architecture using both color filter materials and wavelength dependent silicon absorption

(75) Inventor: Joseph R. Summa, Hilton, NY (US)

Correspondence Address: Thomas H. Close;Patent Legal Staff, Eastman Kodak Company, 343 State Street, Rochester, NY, 14650-2201, US

(73) Assignee: Eastman Kodak Company

(21) Appl. No.: 10/636,410

(22) Filed: Aug. 7, 2003

(51) Int. Cl. H04N 5/335

(52) U.S. Cl. 348/272

(57) ABSTRACT

An image sensor includes a plurality of pixels; a substrate which is doped so that electrons released at different depths in the substrate are collected in separate regions of the substrate; and a color filter array comprising materials that selectively absorb specific bands of wavelengths over predetermined pixels so that wavelengths of light that pass through the color filter array are absorbed by the substrate which releases electrons at different depths of the substrate that are sensed and generate a separate signal for each region.

### FIELD OF THE INVENTION

The invention relates generally to the field of image sensors and, more particularly, to such sensors having a color filter array for separating incoming light and having a substrate which absorbs and stores the separated light in separate regions of the substrate for permitting more efficient color separation.

### BACKGROUND OF THE INVENTION

Current image sensors use a variety of methods for creating color separation. One such method uses the differences in absorption length in silicon of light of different wavelengths for color separation, such as in U.S. Pat. Nos. 5,965,875 and 4,613,895. In this regard, the incoming light is stored in separate regions of the substrate according to its wavelength, and the pixels are arranged so that each pixel receives each color at distinct depths of the silicon.

Another method of producing color separation in image sensors uses color filter arrays, such as in U.S. Pat. No. 3,971,065. In this regard, color filters are placed over the image sensor, and the color filter separates the incoming light so that particular colors are directed onto particular portions of the image sensor, such as is used in the well-known Bayer pattern. In this arrangement, each pixel receives only one color so that interpolation is needed when the entire image is created therefrom.

Although the above method is satisfactory, they include drawbacks. Color cross-talk is an undesirable inherent feature in techniques based on wavelength dependent absorption depths. Color filter arrays suffer from lower sensitivity and aliasing artifacts due to the sampling of color information inherent to the approach. Therefore, an apparatus and method are needed for overcoming the above drawbacks.

### SUMMARY OF THE INVENTION

The present invention is directed to overcoming one or more of the problems set forth above. Briefly summarized, according to one aspect of the present invention, the invention resides in an image comprising a plurality of pixels; a substrate which is doped so that electrons generated (excited) at different depths in the substrate are sensed and a separate signal produced for electrons generated in each region within a pixel; and a color filter array comprising materials that selectively absorb specific bands of wavelengths over predetermined pixels so that wavelengths that pass through the filter array generate electrons at specific depths in the substrate that can be sensed for the separate regions.

These and other aspects, objects, features and advantages of the present invention will be more clearly understood and appreciated from a review of the following detailed description of the preferred embodiments and appended claims, and by reference to the accompanying drawings.

Advantageous Effect of the Invention

The present invention has the advantage of reducing color cross-talk while maintaining efficiency by combining depth dependent light absorption in the substrate and color separation using a color filter before the light enters the substrate. This provides the advantage of a color filter that provides highly efficient color separation and the well structure in the silicon that allows multiple colors per pixel to be collected.

### BRIEF DESCRIPTION OF THE DRAWINGS

FIG. 1 is a top and side view of an image sensor of the present invention;

FIG. 2 is an alternative embodiment of FIG. 1; and

FIG. 3 is a digital camera of the present invention.

### DETAILED DESCRIPTION OF THE INVENTION

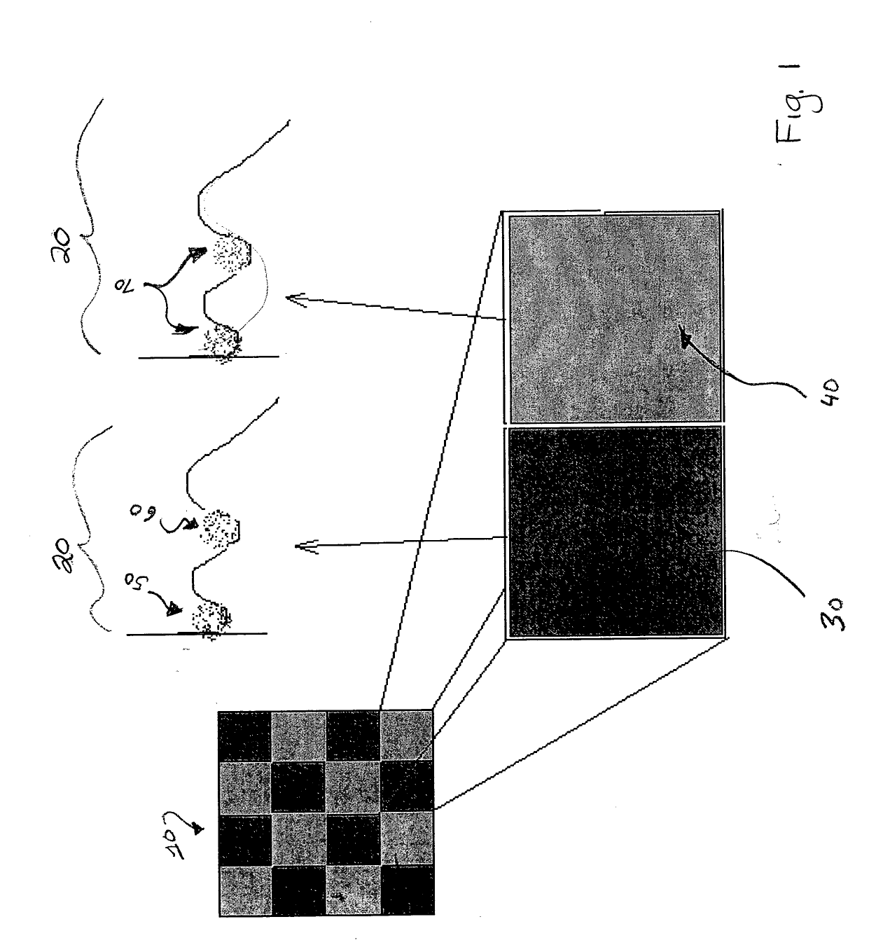

Referring to FIG. 1, there is shown a top and side view of an image sensor of the present invention. The image sensor includes a color filter array 10 positioned covering a silicon substrate 20. The color filter 10 separates the incoming light into substantially distinct portions according to its wavelength so that different colors are absorbed at different wavelengths. In the preferred embodiment, a color filter 10 having an alternating pattern of magenta 30 and green 40 is used so that each pixel respectively receives the light permitted by its respective color filter, magenta and green filter in this embodiment. In this regard, the magenta 30 transmits the blue and red incoming light, and the silicon substrate releases electrons at different depths in the substrate and stores them at different locations respectively 50 and 60. The green filter 40 transmits the green light and the silicon substrate 20 releases electrons at a depth different or the same as the blue and red depth in the substrate and stores it at one or more locations 70. As those skilled in the art may readily recognize, this permits doubling the color sampling frequency while minimizing cross talk as compared to the prior art.

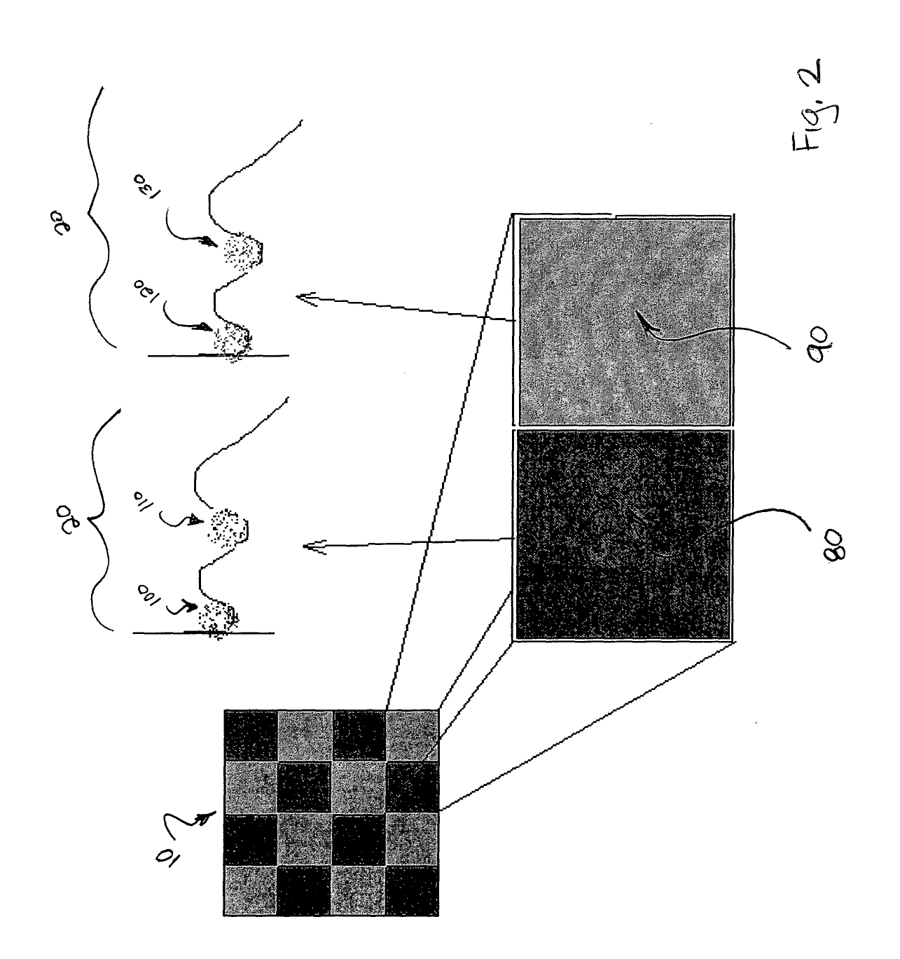

Referring to FIG. 2, there is an alternative embodiment of FIG. 1 having a different color filter arrangement. In this regard, there is an alternating pattern of yellow 80 and cyan 90 filters. Yellow 80 transmits the incoming green and red light causing the silicon substrate to release electrons at different depths in the substrate. These electrons can then be stored at separate locations 100 and 110. The cyan 90 transmits the blue and green incoming light and the silicon causing the silicon substrate to release electrons at different depths in the substrate. These electrons can then be stored at separate locations 120 and 130.

Those skilled in the art will readily recognize that other color filter configurations may be used without departing from the scope of the invention. For example, the sequence of the colors may be changed.

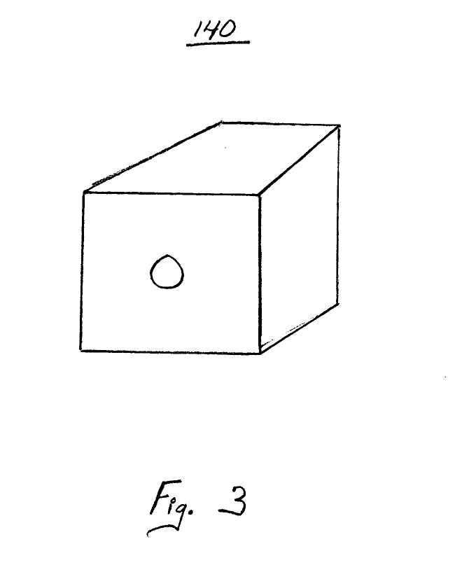

Referring to FIG. 3, there is shown a digital camera 140 of the present invention having a housing enclosing either the image sensor of FIG. 1 or FIG. 2 therein for capturing images. The details of the image sensor have been described hereinabove and need not be repeated again. The digital camera 140 includes other functional components needed for a fully functional camera; all of which are well known in the art and are not repeated herein.

The invention has been described with reference to a preferred embodiment. However, it will be appreciated that variations and modifications can be effected by a person of ordinary skill in the art without departing from the scope of the invention.

### Parts List

10 color filter array
20 silicon substrate
30 pattern of magenta (filter)
40 pattern of green (filter)
50 separate location
60 separate location
70 separate location
80 pattern of yellow (filter)
90 pattern of cyan (filter)
100 separate location
110 separate location
120 separate location
130 separate location
140 digital camera

1. An image sensor comprising:
(a) a plurality of pixels;
(b) a substrate which is doped so that electrons released at different depths in the substrate are sensed and a separate signal produced for separate regions of the substrate; and
(c) a color filter array comprising materials that selectively absorb specific bands of wavelengths spanning predetermined pixels so that wavelengths of light that pass through the color filter array are absorbed by the substrate, which releases electrons at different depths of the substrate and which electrons are sensed and a separate signal produced for each region.

2. The image sensor as in claim 1 wherein the color filter array contains alternating cyan and yellow filters so that the green and blue light passed through the cyan filter is absorbed at different depths of the substrate and which electrons are sensed and a separate signal produced for each region, and green and red light passed through the yellow filter is absorbed at different depths of the substrate and which electrons are sensed and a separate signal produced for each region.

3. The image sensor as in claim 1 wherein the color filter array contains alternating magenta and green filters so that the red and blue light passed through the magenta filter is absorbed at different depths of the substrate and which electrons are sensed and a separate signal produced for each region, and the green light passed through the green filter is contained within a predetermined pixel.

4. A digital camera comprising:
(a) an image sensor comprising:
(i) a plurality of pixels;
(ii) a substrate which is doped so that electrons released at different depths in the substrate are collected in separate regions of the substrate; and
(iii) a color filter array comprising materials that selectively absorb specific bands of wavelengths over predetermined pixels so that wavelengths of light that pass through the color filter array are absorbed by the substrate which releases electrons at different depths of the substrate that are sensed from the separate regions.

5. The digital camera as in claim 4 wherein the color filter array contains alternating cyan and yellow filters so that the green and blue light passed through the cyan filter is absorbed at different depths of the substrate and are sensed from the separate regions, and green and red light passed through the yellow filter is absorbed at different depths of the substrate that are sensed from the separate regions.

6. The digital camera as in claim 5 wherein the color filter array contains alternating magenta and green filters so that the red and blue light passed through the magenta filter is absorbed at different depths of the substrate and is sensed from the separate regions, and the green light passed through the green filter is contained within a predetermined pixel.
